(19) United States
(12) Patent Application Publication
(10) Pub. No.: US 2007/0291035 A1
(43) Pub. Date: Dec. 20, 2007

(54) Horizontal Perspective Representation

(76) Inventors: Michael A. Vesely, Santa Cruz, CA (US); Nancy L. Clemens, Santa Cruz, CA (US)

Correspondence Address: FISH & RICHARDSON P.C., PO BOX 1022, MINNEAPOLIS, MN, 55440-1022, US

(21) Appl. No.: 11/763,407

(22) Filed: Jun. 14, 2007

Related U.S. Application Data
(63) Continuation-in-part of application No. 11/292,379, filed on Nov. 28, 2005.
(60) Provisional application No. 60/632,079, filed on Nov. 30, 2004.

(51) Int. Cl. G06T 15/10

(52) U.S. Cl. 345/427

(57) ABSTRACT

The present disclosure includes, among other things, systems, methods and program products for a creating a horizontal perspective image from a representation.

### CROSS-REFERENCE TO RELATED APPLICATIONS

This application is a continuation-in-part application of, and claims priority to, U.S. patent application Ser. No. 11/292,379, entitled Horizontal Perspective Representation, to Vesely, et al., filed on Nov. 28, 2005, which claims priority to U.S. Provisional Application No. 60/632,079, entitled Horizontal Perspective Representation, to Vesely, et al., filed on Nov. 30, 2004. The disclosures of both of the above applications are incorporated herein by reference in their entirety.

This application is related to U.S. patent application Ser. No. 11/098,681 entitled Horizontal Perspective Display, to Vesely, et al., which was filed on Apr. 4, 2005, and is incorporated herein by reference in its entirety.

This application is related to U.S. patent application Ser. No. 11/141,649 entitled Multi-Plane Horizontal Perspective Display, to Vesely, et al., which was filed on May 31, 2005, and is incorporated herein by reference in its entirety.

### BACKGROUND

Ever since humans began to communicate through pictures, they faced a dilemma of how to accurately represent the three-dimensional (3D) world they lived in. Sculpture was used to successfully depict 3D objects, but was not adequate to communicate spatial relationships between objects and within environments. To do this, early humans attempted to “flatten” what they saw around them onto two-dimensional (2D), vertical planes (e.g. paintings, drawings, tapestries, etc.). Scenes where a person stood upright, surrounded by trees, were rendered relatively successfully on a vertical plane. But how could they represent a landscape, where the ground extended out horizontally from where the artist was standing, as far as the eye could see?

The answer is 3D illusions. The 2D pictures must provide a numbers of cues of the third dimension to the brain to create the illusion of 3D images. This effect of third dimension cues can be realistically achievable due to the fact that the brain is quite accustomed to it. The 3D real world is always and already converted into 2D (e.g. height and width) projected image at the retina, a concave surface at the back of the eye. And from this 2D image, the brain, through experience and perception, generates the depth information to form the three dimension visual image from two types of depth cues: monocular (one eye perception) and binocular (two eye perception). In general, binocular depth cues are innate and biological while monocular depth cues are learned and environmental.

In binocular depth cues, the disparity of the retinal images due to the separation of the two eyes is used to create the perception of depth. The effect is called stereoscopy where each eye receives a slightly different view of a scene, and the brain fuses them together using these differences to determine the ratio of distances between nearby objects. There are also depth cues with only one eye, called monocular depth cues, to create an impression of depth on a flat image.

Perspective drawing, together with relative size, is most often used to achieve the illusion of three dimension depth and spatial relationships on a flat (two dimension) surface, such as paper or canvas. Through perspective, three dimension objects are depicted on a two dimension plane, but “trick” the eye into appearing to be in three dimension space. Some perspective examples are military, cavalier, isometric, and dimetric, as shown at the top of FIG. 1.

Of special interest is the most common type of perspective, called central perspective, shown at the bottom left of FIG. 1. Central perspective, also called one-point perspective, is the simplest kind of “genuine” perspective construction, and is often taught in art and drafting classes for beginners. FIG. 2 further illustrates central perspective. Using central perspective, the chess board and chess pieces look like three dimension objects, even though they are drawn on a 2D flat piece of paper. Central perspective has a central vanishing point, and rectangular objects are placed so their front sides are parallel to the picture plane. The depth of the objects is perpendicular to the picture plane. All parallel receding edges run towards a central vanishing point. The viewer looks towards this vanishing point with a straight view. When an architect or artist creates a drawing using central perspective, they use a single-eye view. That is, the artist creating the drawing captures the image by looking through only one eye, which is perpendicular to the drawing surface.

The vast majority of images, including central perspective images, are displayed, viewed and captured in a plane perpendicular to the line of vision. Viewing the images at angle different from 90° would result in image distortion, meaning a square would be seen as a rectangle when the viewing surface is not perpendicular to the line of vision.

Central perspective is employed extensively in 3D computer graphics, for a myriad of applications, such as scientific, data visualization, computer-generated prototyping, special effects for movies, medical imaging, and architecture, to name just a few.

FIG. 3 illustrates a view volume in central perspective to render computer-generated 3D objects to a computer monitor's vertical, 2D viewing surface. In FIG. 3, a near clip plane is the 2D plane onto which the x, y, z coordinates of the 3D objects within the view volume will be rendered. Each projection line starts at the camera point, and ends at a x, y, z coordinate point of a virtual 3D object within the view volume.

The basis of prior art 3D computer graphics is the central perspective projection. 3D central perspective projection, though offering realistic 3D illusion, has some limitations is allowing the user to have hands-on interaction with the 3D display.

There is a little known class of images that we refer to as “horizontal perspective” images. In a horizontal perspective image, the image appears distorted when viewed head on, but creates a 3D illusion when viewed from the correct viewing position. In horizontal perspective, the angle between the viewing surface and the line of vision is preferably 45° but it can be almost any angle. The viewing surface is preferably horizontal (hence the name “horizontal perspective”), but the viewing surface can be at different orientations as long as the line of vision does not create a perpendicular angle to it.

Horizontal perspective images offer realistic 3D illusion, but are little known primarily due to the narrow viewing location (the viewer's eyepoint has to be coincide precisely with the image projection eyepoint), and the complexity involving in projecting the 2D image or the three dimension model into the horizontal perspective image.

The generation of horizontal perspective images requires considerably more expertise to create than conventional perpendicular images. The conventional perpendicular images can be produced directly from the viewer or camera point. One need simply open one's eyes or point the camera in any direction to obtain the images. Further, with much experience in viewing 3D depth cues from perpendicular images, viewers can tolerate significant amount of distortion generated by the deviations from the camera point. In contrast, the creation of a horizontal perspective image does require much manipulation. Conventional cameras, by projecting the image into the plane perpendicular to the line of sight, would not produce a horizontal perspective image. Manually creating a horizontal perspective drawing requires much effort and is very time consuming. Furthermore, since humans have limited experience with horizontal perspective images, the viewer's eye must be positioned precisely where the projection eyepoint point is to avoid image distortion.

### SUMMARY

In general, one aspect of the subject matter described in this specification can be embodied in a method that includes identifying a set of three dimensional (3D) points for an object, the points obtained from a data source. Each point's associated 3D location is projected onto a drawing plane based on a location for a first eyepoint to create first projected points. A horizontal perspective image is then created in open space from the first projected points. Other implementations of this aspect include corresponding systems, apparatus, and computer program products.

These and other implementations can optionally include one or more of the following features. The data source is one or more of: a two dimensional (2D) image, a 3D image, a 3D model, a 3D object, a virtual world, a 3D chat room, a word processor document, an electronic game, a spreadsheet document, a database, or a network location. Obtaining a set of initial points from the data source, each initial point associated with less than three coordinates or more than three coordinates and determining a 3D location for each point based on the point's associated coordinates to create the set of three dimensional points for the object. A stereoscopic image can be created by projecting each point's 3D location in the set of points onto the drawing plane from a second eyepoint to create second projected points, the second eyepoint being offset from first eyepoint; and creating a second horizontal perspective image in the open space based on the second projected points.

These and other implementations can optionally include one or more of the following additional features. Projecting each point's 3D location in the set of points onto the drawing plane from one or more additional eyepoints to create one or more additional sets of projected points, the additional eyepoints being offset from first eyepoint; and creating one or more additional horizontal perspective images in the open space where each of the additional images is based one of the additional set of projected points. Obtaining audio information associated with a point in the first set of projected points; and causing generation of audio based on the audio information. The generated audio is binaural, stereo or surround sound. Obtaining tactile information associated with a point in the first set of projected points; and causing generation of haptic feedback based on the tactile information. The image is displayed on a substantially horizontal surface.

Particular implementations of the subject matter described in this specification can be implemented to realize one or more of the following advantages. Data is incorporated into a representation which is used to render realistic horizontal perspective 3D images. The horizontal perspective images can be projected into the open space with various peripheral devices that allow the end user to manipulate the images with hands or hand-held tools. The data can come from a variety of sources and be provided in a variety of storage formats.

### BRIEF DESCRIPTION OF THE DRAWINGS

FIG. 1 shows various perspective drawings.

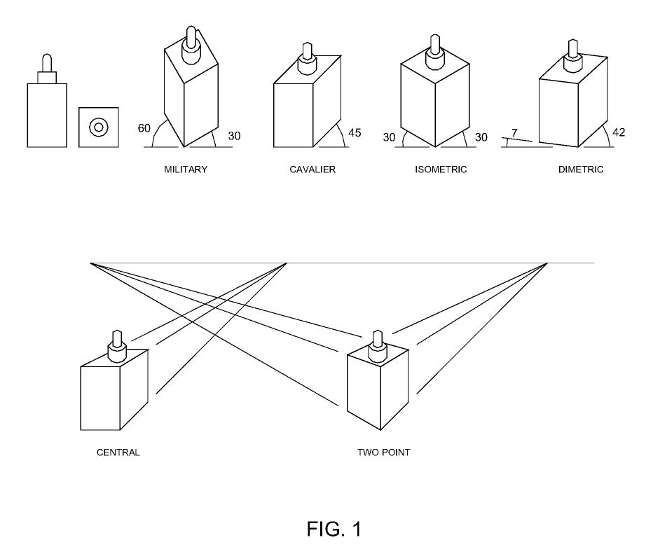

FIG. 2 shows a typical central perspective drawing.

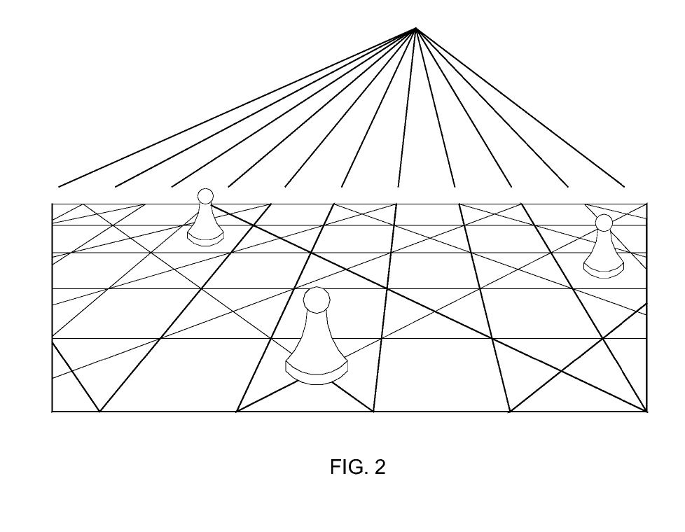

FIG. 3 illustrates a central perspective camera model.

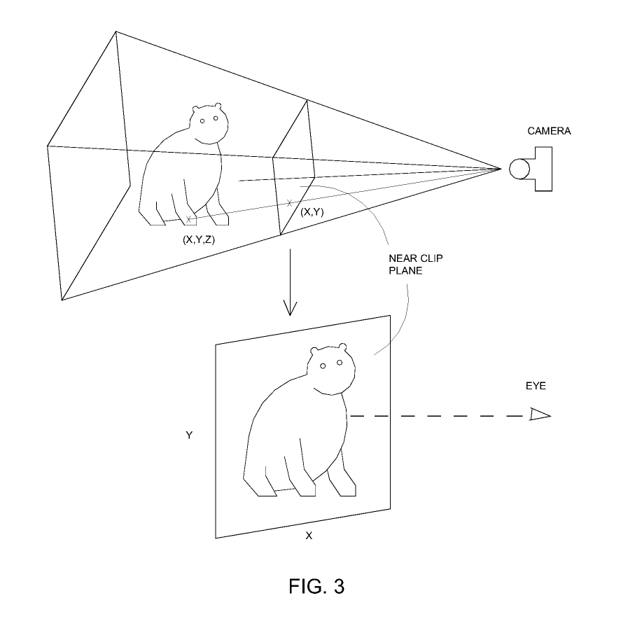

FIG. 4 shows the comparison of central perspective (Image A) and horizontal perspective (Image B).

FIG. 5 shows the central perspective drawing of three stacking blocks.

FIG. 6 shows the horizontal perspective drawing of three stacking blocks.

FIG. 7 shows the method of drawing a horizontal perspective drawing.

FIG. 8 shows mapping of the 3D object onto the horizontal plane.

FIG. 9 shows mapping of the 3D object onto the horizontal plane.

FIG. 10 shows the two-eye view of 3D simulation.

FIG. 11 shows the various 3D peripherals.

FIG. 12 shows the computer interacting in 3D simulation environment.

FIG. 13 shows the computer tracking in 3D simulation environment.

FIG. 14 shows the mapping of virtual attachments to end of tools.

FIG. 15 illustrates a technique for transforming 3D points to horizontal perspective.

FIG. 16 illustrates a system for providing horizontal perspective displays.

FIG. 17 is a schematic diagram of a generic computer system.

Like reference numbers and designations in the various drawings indicate like elements.

### DETAILED DESCRIPTION

Various implementations represent data in 3D horizontal perspective. Horizontal perspective is a little-known perspective, of which we found only two books that describe its mechanics: Stereoscopic Drawing (©1990) and How to Make Anaglyphs (©1979, out of print). Although these books describe this obscure perspective, they do not agree on its name. The first book refers to it as a “free-standing anaglyph,” and the second, a “phantogram.” Another publication called it “projective anaglyph” (U.S. Pat. No. 5,795,154 by G. M. Woods, Aug. 18, 1998). Since there is no agreed-upon name, we have taken the liberty of calling it “horizontal perspective.” Normally, as in central perspective, the plane of vision, at right angle to the line of sight, is also the projected plane of the picture, and depth cues are used to give the illusion of depth to this flat image. In horizontal perspective, the plane of vision remains the same, but the projected image is not on this plane. It is on a plane angled to the plane of vision. Typically, the image would be on the ground level surface. This means the image will be physically in the third dimension relative to the plane of vision. Thus horizontal perspective can be called horizontal projection.

In horizontal perspective, the object is to separate the image from the paper, and fuse the image to the three dimension object that projects the horizontal perspective image. Thus the horizontal perspective image must be distorted so that the visual image fuses to form the free standing 3D figure. It is also essential the image is viewed from the correct eye points, otherwise the 3D illusion is lost. In contrast to central perspective images which have height and width, and project an illusion of depth, and therefore the objects are usually abruptly projected and the images appear to be in layers, the horizontal perspective images have actual depth and width, and illusion gives them height, and therefore there is usually a graduated shifting so the images appear to be continuous.

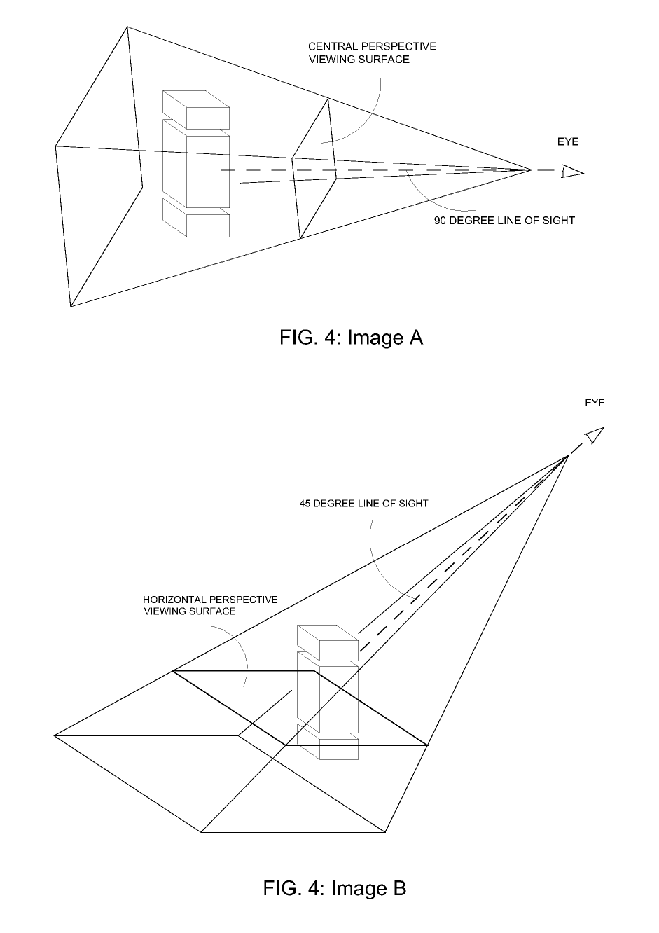

FIG. 4 compares key characteristics that differentiate central perspective and horizontal perspective. Image A shows key pertinent characteristics of central perspective, and Image B shows key pertinent characteristics of horizontal perspective.

In other words, in Image A, the real-life three dimension object (three blocks stacked slightly above each other) was drawn by the artist closing one eye, and viewing along a line of sight perpendicular to the vertical drawing plane. The resulting image, when viewed vertically, straight on, and through one eye, looks the same as the original image.

In Image B, the real-life three dimension object was drawn by the artist closing one eye, and viewing along a line of sight 45° to the horizontal drawing plane. The resulting image, when viewed horizontally, at 45° and through one eye, looks the same as the original image.

One major difference between central perspective showing in Image A and horizontal perspective showing in Image B is the location of the display plane with respect to the projected 3D image. In horizontal perspective of Image B, the display plane can be adjusted up and down, and therefore the projected image can be displayed in the open air above the display plane, i.e. a physical hand can touch (or more likely pass through) the illusion, or it can be displayed under the display plane, i.e. one cannot touch the illusion because the display plane physically blocks the hand. This is the nature of horizontal perspective, and as long as the camera eyepoint and the viewer eyepoint is at the same place, the illusion is present. In contrast, in central perspective of Image A, the 3D illusion is likely to be only inside the display plane, meaning one cannot touch it. To bring the 3D illusion outside of the display plane to allow viewer to touch it, the central perspective would need elaborate display scheme such as surround image projection and large volume.

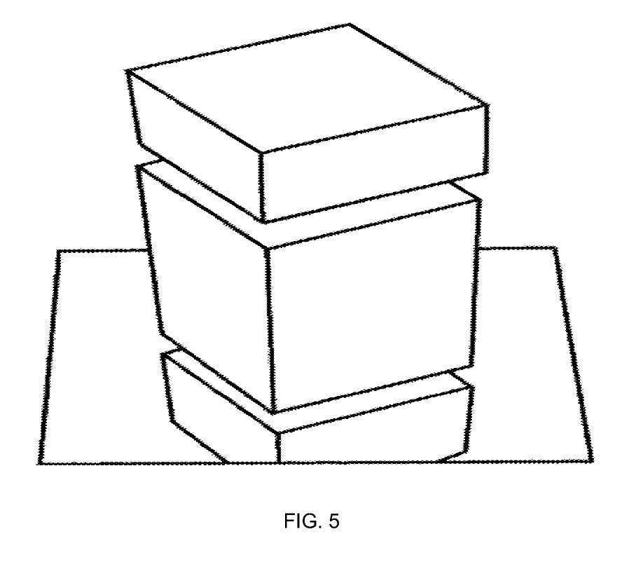

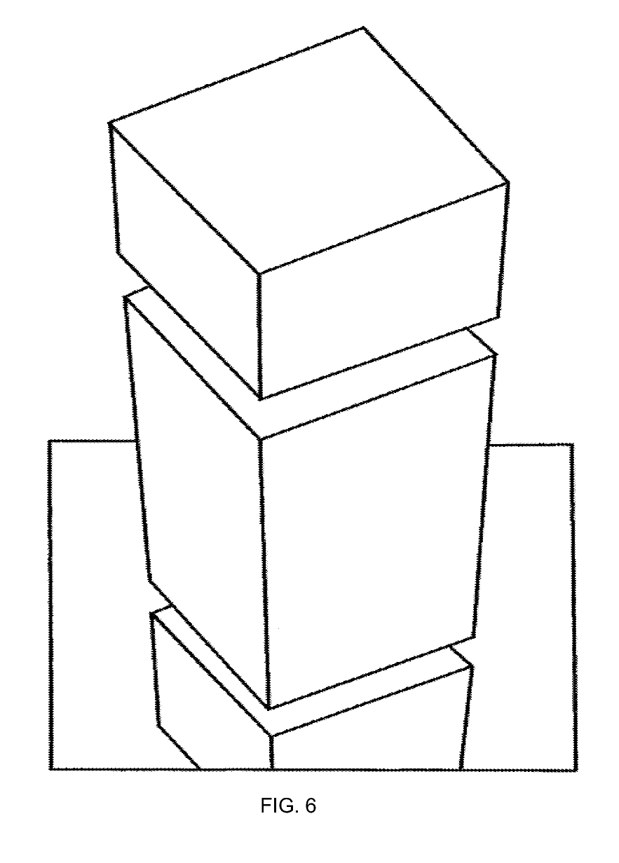

FIGS. 5 and 6 illustrate the visual difference between using central and horizontal perspective. To experience this visual difference, first look at FIG. 5, drawn with central perspective, through one open eye. Hold the piece of paper vertically in front of you, as you would a traditional drawing, perpendicular to your eye. You can see that central perspective provides a good representation of three dimension objects on a two dimension surface.

Now look at FIG. 6, drawn using horizontal perspective, by sifting at your desk and placing the paper lying flat (horizontally) on the desk in front of you. Again, view the image through only one eye. This puts your one open eye, called the eye point at approximately a 45° angle to the paper, which is the angle that the artist used to make the drawing. To get your open eye and its line-of-sight to coincide with the artist's, move your eye downward and forward closer to the drawing, about six inches out and down and at a 45° angle. This will result in the ideal viewing experience where the top and middle blocks will appear above the paper in open space.

Again, the reason your one open eye needs to be at this precise location is because both central and horizontal perspective not only defines the angle of the line of sight from the eye point; they also define the distance from the eye point to the drawing. This means that FIGS. 5 and 6 are drawn with an ideal location and direction for your open eye relative to the drawing surfaces. However, unlike central perspective where deviations from position and direction of the eye point create little distortion, when viewing a horizontal perspective drawing, the use of only one eye and the position and direction of that eye relative to the viewing surface are essential to seeing the open space three dimension horizontal perspective illusion.

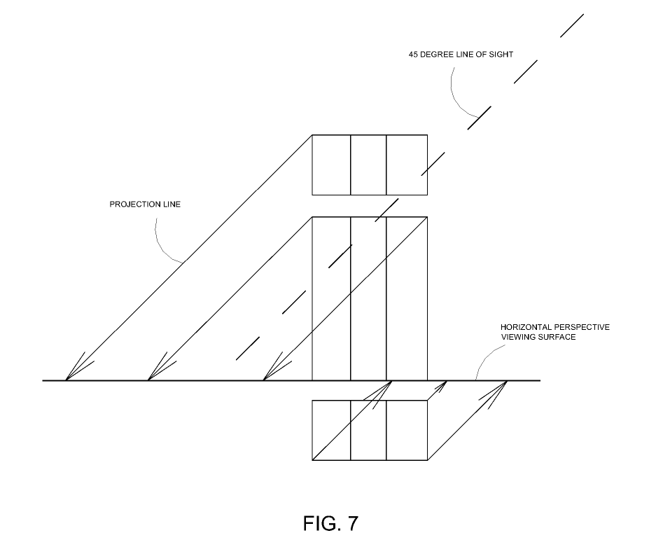

FIG. 7 is an architectural-style illustration that demonstrates a method for making simple geometric drawings on paper or canvas utilizing horizontal perspective. FIG. 7 is a side view of the same three blocks used in FIG. 6. It illustrates the actual mechanics of horizontal perspective. Each point that makes up the object is drawn by projecting the point onto the horizontal drawing plane. To illustrate this, FIG. 7 shows a few of the coordinates of the blocks being drawn on the horizontal drawing plane through projection lines. These projection lines start at the eye point (not shown in FIG. 7 due to scale), intersect a point on the object, then continue in a straight line to where they intersect the horizontal drawing plane, which is where they are physically drawn as a single dot on the paper. When an architect repeats this process for each and every point on the blocks, as seen from the drawing surface to the eye point along the line-of-sight the horizontal perspective drawing is complete, and looks like FIG. 6.

Notice that in FIG. 7, one of the three blocks appears below the horizontal drawing plane. With horizontal perspective, points located below the drawing surface are also drawn onto the horizontal drawing plane, as seen from the eye point along the line-of-site. Therefore when the final drawing is viewed, objects not only appear above the horizontal drawing plane, but may also appear below it as well-giving the appearance that they are receding into the paper. If you look again at FIG. 6, you will notice that the bottom box appears to be below, or go into, the paper, while the other two boxes appear above the paper in open space.

The generation of horizontal perspective images requires considerably more expertise to create than central perspective images. Even though both methods seek to provide the viewer the three dimension illusion that resulted from the 2D image, central perspective images produce directly the 3D landscape from the viewer or camera point. In contrast, the horizontal perspective image appears distorted when viewing head on, but this distortion has to be precisely rendered so that when viewing at a precise location, the horizontal perspective produces a 3D illusion.

The horizontal perspective display system promotes horizontal perspective projection viewing by providing the viewer with the means to adjust the displayed images to maximize the illusion viewing experience. By employing the computation power of the microprocessor and a real time display, the horizontal perspective display, comprising a real time electronic display capable of re-drawing the projected image, together with a viewer's input device to adjust the horizontal perspective image. By re-display the horizontal perspective image so that its projection eyepoint coincides with the eyepoint of the viewer, the horizontal perspective display can ensure the minimum distortion in rendering the three dimension illusion from the horizontal perspective method. The input device can be manually operated where the viewer manually inputs his or her eyepoint location, or change the projection image eyepoint to obtain the optimum 3D illusions. The input device can also be automatically operated where the display automatically tracks the viewer's eyepoint and adjust the projection image accordingly. The horizontal perspective display system removes the constraint that the viewers keeping their heads in relatively fixed positions, a constraint that create much difficulty in the acceptance of precise eyepoint location such as horizontal perspective or hologram display.

The horizontal perspective display system can further include a computation device in addition to the real time electronic display device and projection image input device providing input to the computational device to calculating the projectional images for display to providing a realistic, minimum distortion 3D illusion to the viewer by coincide the viewer's eyepoint with the projection image eyepoint. The system can further comprise an image enlargement/reduction input device, or an image rotation input device, or an image movement device to allow the viewer to adjust the view of the projection images.

The input device can be operated manually or automatically. The input device can detect the position and orientation of the viewer eyepoint, to compute and to project the image onto the display according to the detection result. Alternatively, the input device can be made to detect the position and orientation of the viewer's head along with the orientation of the eyeballs. The input device can comprise an infrared detection system to detect the position the viewer's head to allow the viewer freedom of head movement. Other implementations of the input device can be the triangulation method of detecting the viewer eyepoint location, such as a CCD camera providing position data suitable for the head tracking objectives. The input device can be manually operated by the viewer, such as a keyboard, mouse, trackball, joystick, or the like, to indicate the correct display of the horizontal perspective display images.

The horizontal perspective image projection employs the open space characteristics, and thus enables an end user to interact physically and directly with real-time computer-generated 3D graphics, which appear in open space above the viewing surface of a display device, i.e. in the end user's own physical space.

In horizontal perspective, the computer hardware viewing surface is preferably situated horizontally, such that the end-user's line of sight is at a 45° angle to the surface. Typically, this means that the end user is standing or seated vertically, and the viewing surface is horizontal to the ground. Note that although the end user can experience hands-on simulations at viewing angles other than 45° (e.g. 55°, 30° etc.), it is the optimal angle for the brain to recognize the maximum amount of spatial information in an open space image. Therefore, for simplicity's sake, we use “45°” throughout this document to mean “an approximate 45 degree angle”. Further, while horizontal viewing surface is preferred since it simulates viewers' experience with the horizontal ground, any viewing surface could offer similar 3D illusion experience. The horizontal perspective illusion can appear to be hanging from a ceiling by projecting the horizontal perspective images onto a ceiling surface, or appear to be floating from a wall by projecting the horizontal perspective images onto a vertical wall surface.

The horizontal perspective display creates a “Hands-On Volume” and a “Inner-Access Volume.” The Hands-On Volume is situated on and above the physical viewing surface. Thus the end user can directly, physically manipulate simulations because they co-inhabit the end-user's own physical space. This 1:1 correspondence allows accurate and tangible physical interaction by touching and manipulating simulations with hands or hand-held tools. The Inner-Access Volume is located underneath the viewing surface and simulations within this volume appear inside the physically viewing device. Thus simulations generated within the Inner-Access Volume do not share the same physical space with the end user and the images therefore cannot be directly, physically manipulated by hands or hand-held tools. That is, they are manipulated indirectly via a computer mouse or a joystick.

Existing 3D-graphics engine uses central-perspective and therefore a vertical plane to render its view volume while a “horizontal” oriented rendering plane vs. a “vertical” oriented rendering plane is required to generate horizontal perspective open space images. The horizontal perspective images offer much superior open space access than central perspective images.

To accomplish the Hands-On Volume simulation, a synchronization is requires between the computer-generated world and their physical real-world equivalents. Among other things, this synchronization insures that images are properly displayed, preferably through a Reference Plane calibration.

A computer monitor or viewing device is made of many physical layers, individually and together having thickness or depth. For example, a typical CRT-type viewing device would include a the top layer of the monitor's glass surface (the physical “View Surface”), and the phosphor layer (the physical “Image Layer”), where images are made. The View Surface and the Image Layer are separate physical layers located at different depths or z coordinates along the viewing device's z axis. To display an image the CRT's electron gun excites the phosphors, which in turn emit photons. This means that when you view an image on a CRT, you are looking along its z axis through its glass surface, like you would a window, and seeing the light of the image coming from its phosphors behind the glass. Thus without a correction, the physical world and the computer simulation are shifted by this glass thickness.

An Angled Camera point is a point initially located at an arbitrary distance from the displayed and the camera's line-of-site is oriented at a 45° angle looking through the center. The position of the Angled Camera in relation to the end-user's eye is critical to generating simulations that appear in open space on and above the surface of the viewing device.

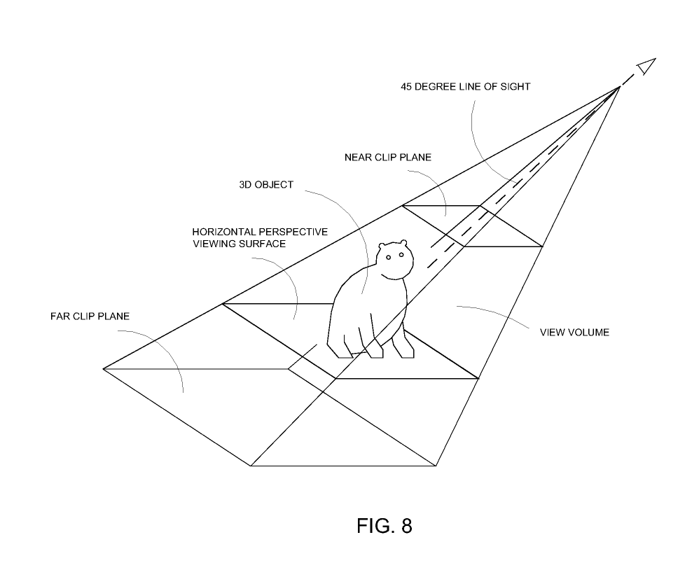

Mathematically, the computer-generated x, y, z coordinates of the Angled Camera point form the vertex of an infinite “pyramid”, whose sides pass through the x, y, z coordinates of the Reference/Horizontal Plane. FIG. 8 illustrates this infinite pyramid, which begins at the Angled Camera point and extending through the Far Clip Plane.

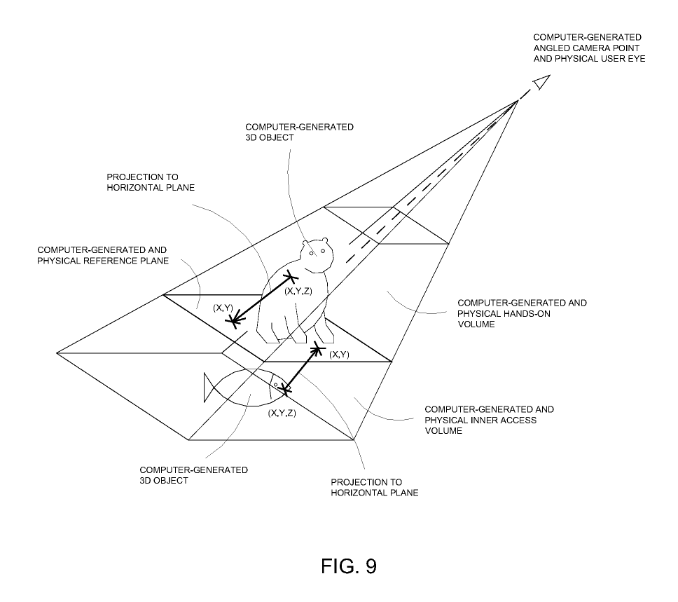

As a projection line in either the Hands-On and Inner-Access Volume intersects both an object point and the offset Horizontal Plane, the 3D x, y, z point of the object becomes a two-dimensional x, y point of the Horizontal Plane (see FIG. 9). Projection lines often intersect more than one 3D object coordinate, but only one object x, y, z coordinate along a given projection line can become a Horizontal Plane x, y point. The formula to determine which object coordinate becomes a point on the Horizontal Plane is different for each volume. For the Hands-On Volume it is the object coordinate of a given projection line that is farthest from the Horizontal Plane. For the Inner-Access Volume it is the object coordinate of a given projection line that is closest to the Horizontal Plane. In case of a tie, i.e. if a 3D object point from each volume occupies the same 2D point of the Horizontal Plane, the Hands-On Volume's 3D object point is used.

The hands-on simulator also allows the viewer to move around the 3D display and yet suffer no great distortion since the display can track the viewer eyepoint and re-display the images correspondingly, in contrast to the conventional prior art 3D image display where it would be projected and computed as seen from a singular viewing point, and thus any movement by the viewer away from the intended viewing point in space would cause gross distortion.

The display system can further comprise a computer capable of re-calculate the projected image given the movement of the eyepoint location. The horizontal perspective images can be very complex, tedious to create, or created in ways that are not natural for artists or cameras, and therefore require the use of a computer system for the tasks. To display a three-dimensional image of an object with complex surfaces or to create animation sequences would demand a lot of computational power and time, and therefore it is a task well suited to the computer. 3D capable electronics and computing hardware devices and real-time computer-generated 3D computer graphics have advanced significantly recently with marked innovations in visual, audio and tactile systems, and have producing excellent hardware and software products to generate realism and more natural computer-human interfaces.

The horizontal perspective display system are not only in demand for entertainment media such as televisions, movies, and video games but are also needed from various fields such as education (displaying three-dimensional structures), technological training (displaying three-dimensional equipment). There is an increasing demand for three-dimensional image displays, which can be viewed from various angles to enable observation of real objects using object-like images. The horizontal perspective display system is also capable of substitute a computer-generated reality for the viewer observation. The systems may include audio, visual, motion and inputs from the user in order to create a complete experience of 3D illusions.

The input for the horizontal perspective system can be 2D image, several images combined to form one single 3D image, or 3D model. The 3D image or model conveys much more information than that a 2D image and by changing viewing angle, the viewer will get the impression of seeing the same object from different perspectives continuously.

The horizontal perspective display can further provide multiple views or “Multi-View” capability. Multi-View provides the viewer with multiple and/or separate left-and right-eye views of the same simulation. Multi-View capability is a significant visual and interactive improvement over the single eye view. In Multi-View mode, both the left eye and right eye images are fused by the viewer's brain into a single, three-dimensional illusion. The problem of the discrepancy between accommodation and convergence of eyes, inherent in stereoscopic images, leading to the viewer's eye fatigue with large discrepancy, can be reduced with the horizontal perspective display, especially for motion images, since the position of the viewer's gaze point changes when the display scene changes.

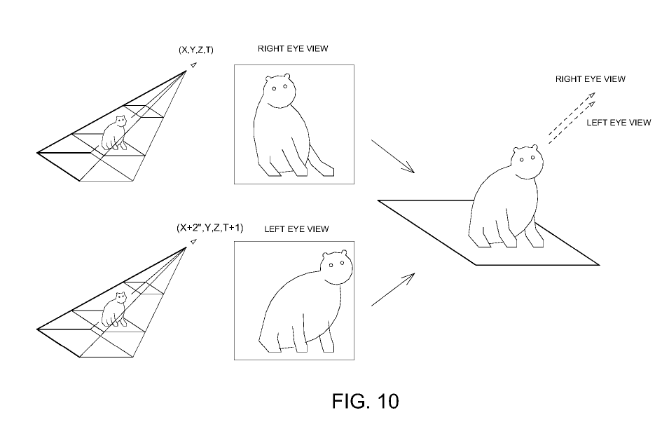

FIG. 10 helps illustrate these two stereoscopic and time simulations. The computer-generated person has both eyes open, a requirement for stereoscopic 3D viewing, and therefore sees the bear cub from two separate vantage points, i.e. from both a right-eye view and a left-eye view. These two separate views are slightly different and offset because the average person's eyes are about 2 inches apart. Therefore, each eye sees the world from a separate point in space and the brain puts them together to make a whole image. There are existing stereoscopic 3D viewing devices that require more than a separate left- and right-eye view. But because the method described here can generate multiple views it works for these devices as well.

The distances between people's eyes vary but in the above example we are using the average of 2 inches. It is also possible for the end user to provide their personal eye separation value. This would make the x value for the left and right eyes highly accurate for a given end user and thereby improve the quality of their stereoscopic 3D view.

In Multi-View mode, the objective is to simulate the actions of the two eyes to create the perception of depth, namely the left eye and the right eye sees slightly different images. Thus Multi-View devices include methods with glasses such as anaglyph method, special polarized glasses or shutter glasses, methods without using glasses such as a parallax stereogram, a lenticular method, and mirror method (concave and convex lens).

In anaglyph method, a display image for the right eye and a display image for the left eye are respectively superimpose-displayed in two colors, e.g., red and blue, and observation images for the right and left eyes are separated using color filters, thus allowing a viewer to recognize a stereoscopic image. The images are displayed using horizontal perspective technique with the viewer looking down at an angle. As with one eye horizontal perspective method, the eyepoint of the projected images has to be coincide with the eyepoint of the viewer, and therefore the viewer input device is essential in allowing the viewer to observe the 3D horizontal perspective illusion. From the early days of the anaglyph method, there are much improvements such as the spectrum of the red/blue glasses and display to generate much more realism and comfort to the viewers.

In polarized glasses method, the left eye image and the right eye image are separated by the use of mutually extinguishing polarizing filters such as orthogonally linear polarizer, circular polarizer, elliptical polarizer. The images are normally projected onto screens with polarizing filters and the viewer is then provided with corresponding polarized glasses. The left and right eye images appear on the screen at the same time, but only the left eye polarized light is transmitted through the left eye lens of the eyeglasses and only the right eye polarized light is transmitted through the right eye lens.

Another way for stereoscopic display is the image sequential system. In such a system, the images are displayed sequentially between left eye and right eye images rather than superimposing them upon one another, and the viewer's lenses are synchronized with the screen display to allow the left eye to see only when the left image is displayed, and the right eye to see only when the right image is displayed. The shuttering of the glasses can be achieved by mechanical shuttering or with liquid crystal electronic shuttering. In shuttering glass method, display images for the right and left eyes are alternately displayed on a CRT in a time sharing manner, and observation images for the right and left eyes are separated using time sharing shutter glasses which are opened/closed in a time sharing manner in synchronism with the display images, thus allowing an observer to recognize a stereoscopic image.

Other way to display stereoscopic images is by optical method. In this method, display images for the right and left eyes, which are separately displayed on a viewer using optical means such as prisms, mirror, lens, and the like, are superimpose-displayed as observation images in front of an observer, thus allowing the observer to recognize a stereoscopic image. Large convex or concave lenses can also be used where two image projectors, projecting left eye and right eye images, are providing focus to the viewer's left and right eye respectively. A variation of the optical method is the lenticular method where the images form on cylindrical lens elements or 2D array of lens elements.

Depending on the stereoscopic 3D viewing device used, the horizontal perspective display continues to display the left- and right-eye images, as described above, until it needs to move to the next display time period. An example of when this may occur is if the bear cub moves his paw or any part of his body. Then a new and second simulated image would be required to show the bear cub in its new position. This process of generating multiple views via the nonstop incrementing of display time continues as long as the horizontal perspective display is generating real-time simulations in stereoscopic 3D.

By rapidly display the horizontal perspective images, 3D illusion of motion can be realized. Typically, 30 to 60 images per second would be adequate for the eye to perceive motion. For stereoscopy, the same display rate is needed for superimposed images, and twice that amount would be needed for time sequential method.

The display rate is the number of images per second that the display uses to completely generate and display one image. This is similar to a movie projector where 24 times a second it displays an image. Therefore, 1/24 of a second is required for one image to be displayed by the projector. But the display time could be a variable, meaning that depending on the complexity of the view volumes it could take 1/120, 1/12 or ½ a second for the computer to complete just one display image. Since the display was generating a separate left and right eye view of the same image, the total display time is twice the display time for one eye image.

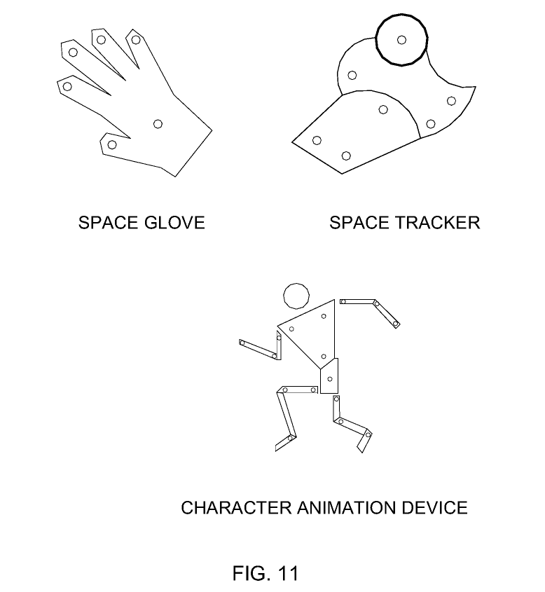

The system further includes technologies employed in computer “peripherals”. FIG. 11 shows examples of such peripherals with six degrees of freedom, meaning that their coordinate system enables them to interact at any given point in an (x, y, z) space. The examples of such peripherals are Space Glove, Space Tracker, or Character Animation Device.

Some peripherals provide a mechanism that enables the simulation to perform this calibration without any end-user involvement. But if calibrating the peripheral requires external intervention than the end-user will accomplish this through a calibration procedure. Once the peripheral is calibrated, the simulation will continuously track and map the peripheral.

With the peripherals linking to the simulator, the user can interact with the display model. The simulation can get the inputs from the user through the peripherals, and manipulate the desired action. With the peripherals properly matched with the physical space and the display space, the simulator can provide proper interaction and display. The peripheral tracking can be done through camera triangulation or through infrared tracking devices.

The simulator can further include 3D audio devices. Object Recognition is a technology that uses cameras and/or other sensors to locate simulations by a method called triangulation. Triangulation is a process employing trigonometry, sensors, and frequencies to “receive” data from simulations in order to determine their precise location in space. It is for this reason that triangulation is a mainstay of the cartography and surveying industries where the sensors and frequencies they use include but are not limited to cameras, lasers, radar, and microwave. 3D Audio also uses triangulation but in the opposite way 3D Audio “sends” or projects data in the form of sound to a specific location. But whether you're sending or receiving data the location of the simulation in three-dimensional space is done by triangulation with frequency receiving/sending devices. By changing the amplitudes and phase angles of the sound waves reaching the user's left and right ears, the device can effectively emulate the position of the sound source. The sounds reaching the ears will need to be isolated to avoid interference. The isolation can be accomplished by the use of earphones or the like.

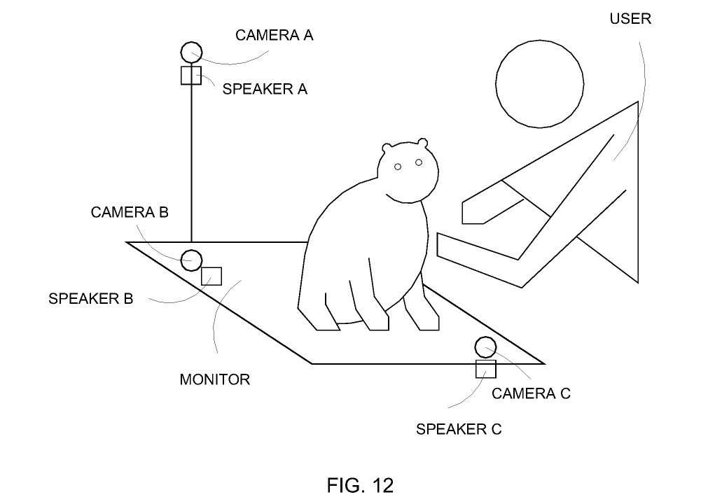

FIG. 12 shows an end-user looking at an image of a bear cub. Since the cub appears in open space above the viewing surface the end-user can reach in and manipulate the cub by hand or with a handheld tool. It is also possible for the end-user to view the cub from different angles, as they would in real life. This is accomplished though the use of triangulation where the three real-world cameras continuously send images from their unique angle of view to the computer. This camera data of the real world enables the computer to locate, track, and map the end-user's body and other real-world simulations positioned within and around the computer monitor's viewing surface.

FIG. 12 also shows the end-user viewing and interacting with the bear cub, but it includes 3D sounds emanating from the cub's mouth. To accomplish this level of audio quality requires physically combining each of the three cameras with a separate speaker. The cameras' data enables the computer to use triangulation in order to locate, track, and map the end-user's “left and right ear”. And since the computer is generating the bear cub, it knows the exact location of the cub's mouth. By knowing the exact location of the end-user's ears and the cub's mouth the computer uses triangulation to sends data, by modifying the spatial characteristics of the audio, making it appear that 3D sound is emanating from the cub's computer-generated mouth. Note that other sensors and/or transducers may be used as well.

Triangulation works by separating and positioning each camera/speaker device such that their individual frequency receiving/sending volumes overlap and cover the exact same area of space. If you have three widely spaced frequency receiving/sending volumes covering the exact same area of space than any simulation within the space can accurately be located.

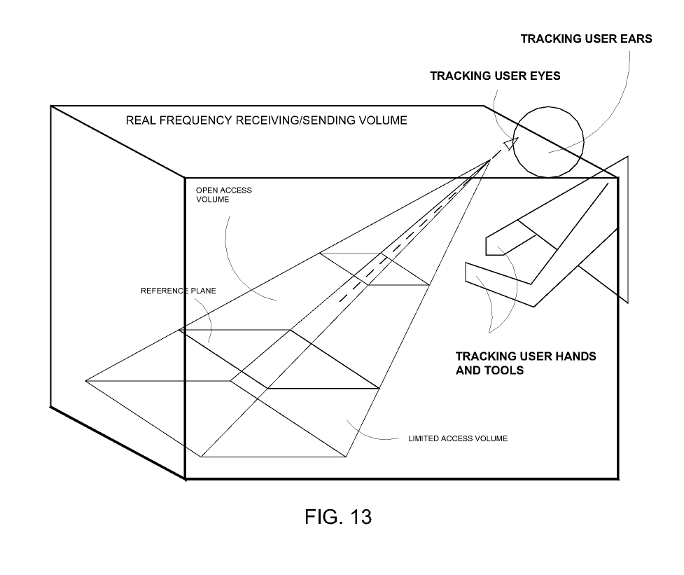

As shown in FIG. 13, the simulator then performs simulation recognition by continuously locating and tracking the end-user's “left and right eye” and their “line-of-sight”, continuously map the real-world left and right eye coordinates precisely where they are in real space, and continuously adjust the computer-generated cameras coordinates to match the real-world eye coordinates that are being located, tracked, and mapped. This enables the real-time generation of simulations based on the exact location of the end-user's left and right eye. It also allows the end-user to freely move their head and look around the images without distortion.

The simulator then perform simulation recognition by continuously locating and tracking the end-user's “left and right ear” and their “line-of-hearing”, continuously map the real-world left- and right-ear coordinates precisely where they are in real space, and continuously adjust the 3D Audio coordinates to match the real-world ear coordinates that are being located, tracked, and mapped. This enables the real-time generation of sounds based on the exact location of the end-user's left and right ears. It also allows the end-user to freely move their head and still hear sounds emanating from their correct location.

The simulator then perform simulation recognition by continuously locating and tracking the end-user's “left and right hand” and their “digits,” i.e. fingers and thumbs, continuously map the real-world left and right hand coordinates precisely where they are in real space, and continuously adjust the coordinates to match the real-world hand coordinates that are being located, tracked, and mapped. This enables the real-time generation of simulations based on the exact location of the end-user's left and right hands, allowing the end-user to freely interact with simulations.

The simulator then perform simulation recognition by continuously locating and tracking “handheld tools”, continuously map these real-world handheld tool coordinates precisely where they are in real space, and continuously adjust the coordinates to match the real-world handheld tool coordinates that are being located, tracked, and mapped. This enables the real-time generation of simulations based on the exact location of the handheld tools, allowing the end-user to freely interact with simulations.

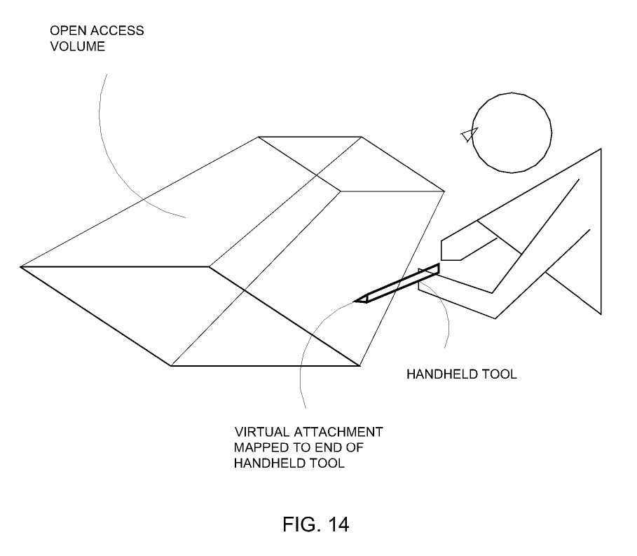

FIG. 14 is intended to assist in further explaining the handheld tools. The end-user can probe and manipulated the simulations by using a handheld tool, which in FIG. 14 looks like a pointing device. A “computer-generated attachment” is mapped in the form of a computer-generated simulation onto the tip of a handheld tool, which in FIG. 14 appears to the end-user as a computer-generated “eraser”. The end-user can of course request that the computer maps any number of computer-generated attachments to a given handheld tool. For example, there can be different computer-generated attachments with unique visual and audio characteristics for cutting, pasting, welding, painting, smearing, pointing, grabbing, etc. And each of these computer-generated attachments would act and sound like the real device they are simulating when they are mapped to the tip of the end-user's handheld tool.

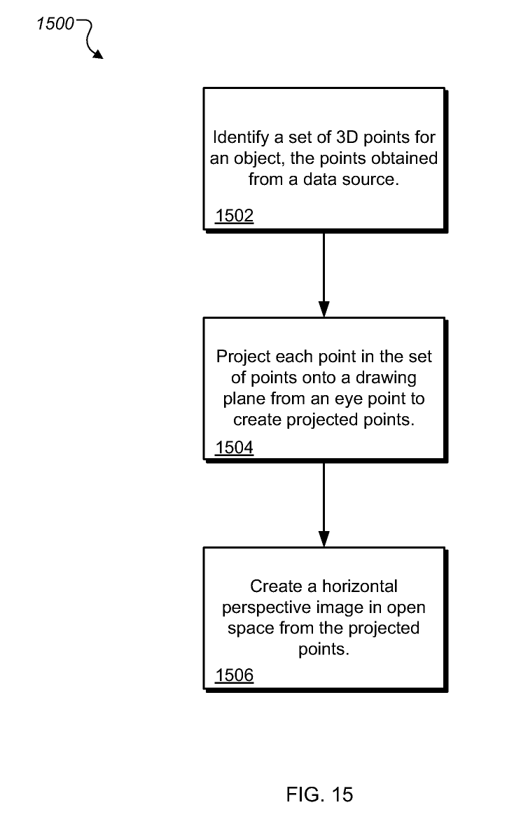

FIG. 15 is a flowchart illustrating a technique 1500 for transforming 3D points to horizontal perspective in order to create realistic 3D images. Initially, a set of 3D points for an object are identified (1502). A point is an element that has a position or location in an N dimensional space. A position is typically represented by three coordinates (e.g., an x, y and z coordinate) but there can be fewer or more coordinates, as discussed below. A point is optionally associated with other information such as color, magnitude, or other values. By way of illustration, a point can be associated with information for color, intensity, transparency, or combinations of these that describe the visual appearance of the object at a particular location in space. A point can be the location of a wine-colored image pixel in a 3D image of a human heart, for instance. Color information is typically specified in terms of a color space, e.g., Red, Green and Blue (RGB); Cyan, Magenta, Yellow and Black (CMYK); CIELAB, CIE XYZ, CIE LUV, Yellow Chromate Conversion (YCC); YIQ, Hue, Saturation and Brightness (HSB); Hue, Saturation, and Lightness (HSL); or Grayscale. A color space determines how values can be interpreted as a color. For example, in an RGB encoded image, a color is encoded by at least three values corresponding to each of RGB's three color components: red, green and blue.

By way of further illustration, a 3D point can also be associated with information that can be used to determine tactile and sound properties of the object for purposes of user interaction with the object in open space. Other perceptual quantities can be associated with a 3D point. Tactile properties such as whether the object feels rubbery or hard to the touch at a given location can be specified as surface characteristics or material properties of the point's location. As described above, the end-user can probe and manipulate objects in open space by using a handheld tool, which in FIG. 14 appears as a pointing device. Kinetic feedback can be provided to a handheld tool based on the tactile properties of points the tool is interacting with. The feedback can be in the form of vibrations or resistance in the tool, for example, or other mechanical or electrical responses. Likewise, audio properties for a given location such as the sound emitted when the location is touched or manipulated can be associated with a 3D point. Audio and kinetic feedback can be provided in response to user interaction with the hands-on volume or irrespective of user interaction with the hands-on volume. In some implementations, audio properties can be inferred from tactile properties. For example, if a point's tactile property specifies that the point is metal, the potential types of sounds that can be made from interaction with the point can be generated based on the material type, or vice versa.

In various implementations, a set of N dimensional points, where N≠3, can be converted to a set of 3D points. A point coordinate represents a location along a dimensional axis where the dimension can be location, time, color, temperature, or any other type of quantity or property. In the case where N<3, the one or two additional dimensions can be inferred or extrapolated for each point from the specified coordinate(s). And the same can be done for associated information, such as converting 2D sound to 3D sound, for example. For example, a 2D image is comprised of a raster of pixels where each pixel has an x,y coordinate for its location in the raster relative to other pixels. A depth coordinate can be inferred for each pixel location based on analysis of the image's color or intensity information. Depth can sometimes be determined based on detecting objects in an image and determining the distance of the objects from a virtual camera based on how the objects overlap with each other and other clues such as shadows and the relative size of the objects, for instance. In the case where N>3, various techniques can be used to determine how to convert or map the dimensions to just three dimensions. For example, a coordinate in a five dimensional space can be projected or mapped to lower dimensional spaces.

Data points are obtained from a data source such as one or more files, databases or running processes. In the case of a running process, the process can provide data points locally on the same computing device as the horizontal perspective display system or from a non-local computing device such that data points are delivered in one or more messages (e.g., as a stream) or memory locations to the horizontal perspective display system. A running process can be, for instance, a process without a graphical user interface (GUI) such as a server or a process with a GUI such as a word processor application, an electronic spreadsheet, a web browser, an electronic game (2D or 3D), a virtual world (e.g., World of Warcraft, Second Life) or 3D chat room, for example. By way of illustration, an electronic spreadsheet can have an embedded 3D graph whose underlying data points can be exported to the horizontal perspective display system by means of a communication protocol between the system and the application. In some implementations, the GUI-based process can include a so-called plug-in module or other capability which allows the user to manually or automatically export 3D points from the application to the horizontal perspective display system.

In various implementations, data points and associated information (e.g., tactile and sound information) are stored in one or more formats, such as the 3D formats described in TABLE 1 and the 2D formats described in TABLE 2, for instance. By way of illustration, a format can represent a single 2D or 3D image, a polygon mesh, a set of non-uniform rational B-splines (NURBS), a computer aided design model, a 3D model, a 3D object, or can represent a sequence of formatted data (e.g., MPEG-4). However, other formats are possible. Moreover, a format does not necessarily correspond to an electronic file. A format may be stored in a portion of a file that holds other content in possibly a different format, in a single file dedicated to the content in question, or in multiple coordinated files.

TABLE 1

| DATA FORMAT | DESCRIPTION |
|---|---|
| Universal 3D (U3D) | A universal format for sharing 3D drawings on |
| | the Web and in common office applications. |
| Virtual Reality | A text file format for representing 3D |
| Modeling | polygonal meshes and surface properties such |
| Language (VRML) | as color, textures, transparency and |
| | shininess. |
| X3D | An ISO standard for real-time 3D computer |
| | graphics and is the successor to VRML. |
| QuickTime VR (QTVR) | A digital video standard developed by Apple |
| | in Cupertino, California. |
| Moving Picture | A video and audio compression format that |
| Experts | supports 3D content. |
| Group 4 (MPEG-4) | |
| Digital Imaging and | A standard for handling, storing, printing, |
| Communications in | and transmitting medical imaging for |
| Medicine (DICOM) | radiology, cardiology, oncology, radio |
| | therapy, ophthalmology, dentistry, pathology, |
| | neurology, for example. |
| 3D Image | An image that creates the illusion of depth |
| | typically by presenting a slightly different |
| | image to each eye. |
| CAD Model, 3D Model, | A mathematical representation of a 3D object. |
| or 3D Object | |

TABLE 2

| DATA FORMAT | DESCRIPTION |
|---|---|
| Joint Photographic Expert | A common image compression format. |
| Group (JPEG) | |
| Portable Network Graphics | A bitmapped image format based on lossless |
| (PNG) | data compression. |
| Graphic Interchange Format | An 8-bit per pixel image format. |
| (GIF) | |
| Bitmap (BMP) | A bitmapped graphics format for Microsoft |
| | Windows. |
| Tagged Image File Format | An adaptable file format that can represent |
| (TIFF) | multiple images and data in a single file. |

In various implementations, data points and associated information are stored in other formats such as those described in TABLE 3, for example.

TABLE 3

| DATA FORMAT | DESCRIPTION |
|---|---|
| Portable Document | A desktop publishing file format created by |
| Format (PDF) | Adobe Systems Incorporated for describing 2D |
| | and 3D documents. |
| Microsoft Word XML | Document format for Microsoft Corporation's |
| | word processing application. |
| Microsoft Excel | Document format for Microsoft Corporation's |
| Workbook | spreadsheet application. |
| eXtensible Markup | A human-readable data markup language |
| Language (XML) | maintained by the World Wide Web |
| | Consortium. |
| Hypertext Markup | A markup language for web pages. |
| Language (HTML) | |

Each format described in TABLES 1-3 has a documented layout that allows point data and associated information to be programmatically stored in and extracted from files or memory buffers containing data conforming to the format. By way of illustration, a Microsoft Word document can be parsed to find a set of points (e.g., in a table) or the Word document can be rendered to create a raster of 2D color points representing a page in the document. Each 2D color point can then be assigned a depth value to make the rendered document appear as if it were a piece of paper in a horizontal perspective projection.

Referring again to FIG. 15, each point in the set of points is then mathematically projected onto an imaginary drawing plane (e.g., a horizontal drawing plane) from an eyepoint to create a set of projected points (1504). As shown in FIG. 7 and the accompanying text above, each point's location on the horizontal drawing plane is where a straight line passing through the eyepoint and the 3D point intersects the plane. Next, an image is created in open space from the projected points based on horizontal perspective (1506) by displaying the image on a horizontal display device. The horizontal perspective images can be projected into the open space with various peripheral devices that allow the end user to manipulate the images with their hands or hand-held tools.

By way of illustration, a doctor or other medical professional can use the horizontal perspective display system to view a 3D horizontal perspective presentation of a patient's Magnetic Resonance Imaging (MRI) images (e.g., in DICOM format) of a broken bone while also viewing a virtual page from an electronic book (ebook) concerning a related medical subject. The ebook could be represented as a PDF file that contains U3D illustrations of anatomy, for example. By way of further illustration, the doctor can interactively zoom in and rotate a section of the bone break using a handheld tool. In some instances, the doctor may be able to view layers with sections of bone.

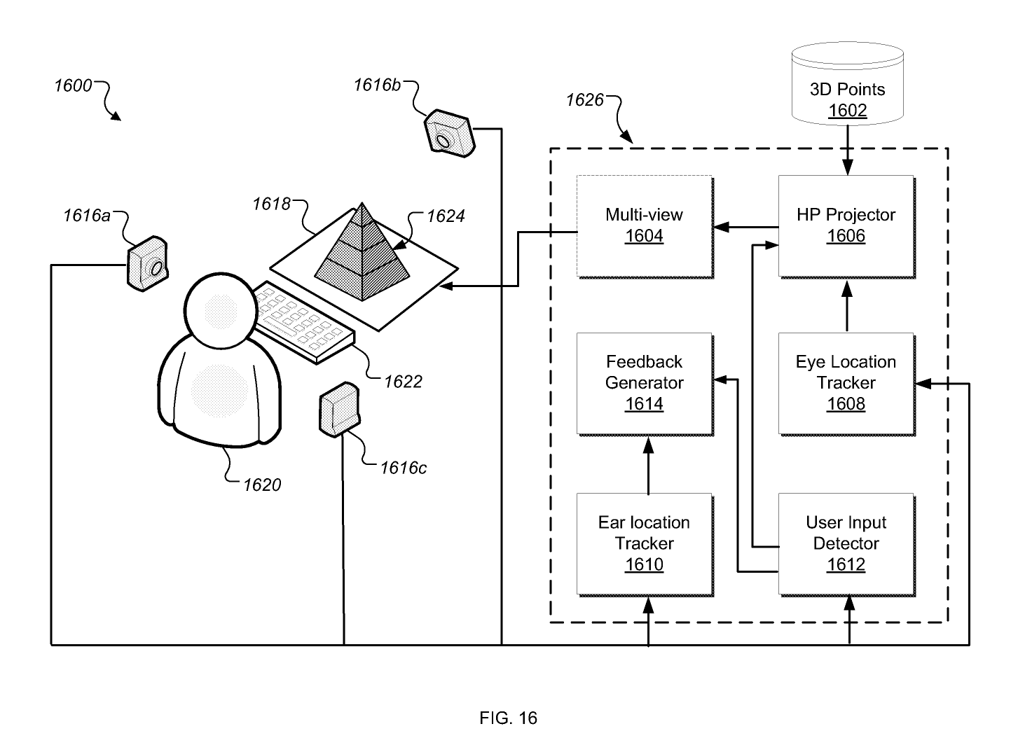

FIG. 16 illustrates a system 1600 for providing horizontal perspective displays. A horizontal display 1618, such as a liquid crystal display, is used to present a 3D horizontal perspective image 1624, as described above. A user 1620 can interact with the image 1624 through a keyboard 1622 or other input devices such as, but not limited to, computer mice, trackballs, handheld tools (e.g., see FIG. 14), gestures (e.g., hand or finger movements), sounds or voice commands, or other forms of user input. Digital video cameras or infrared cameras 1616a-c are used for tracking the user 1620's ear and eye locations to optimize 3D sound and the image 1624, respectively. The cameras 1616a-c can also be used for tracking the user 1620's hand and body locations for purposes of detecting user interaction with the open space.

The system 1600 also includes one or more computing devices 1626 for execution of various software components. Although several components are illustrated, there may be fewer or more components in the system 1600. Moreover, the components can be distributed on one or more computing devices connected by one or more networks or other suitable communication means.

A data source 1602 such as a file or a running process provides data points to a horizontal projection component 1606 which takes the points and performs a horizontal projection on them, taking into account the position of the user 1620's line of sight—the eyepoint—as determined by an eye location tracker component 1608 so that the projection will not appear distorted to the user 1620. A multi-view component 1604 optionally provides the user 1620 with separate left-and right-eye views to create the illusion of 3D in the user 1620's mind. In various implementations, the data points and their associated information can be represented in computer memory as a graph or a polygon mesh data structure, for instance.

The eye location tracker 1608 analyzes data coming from one or more of the cameras 1616a-c to determine the precise location of the user 1620's line of sight. This can be accomplished by using object tracking techniques to analyze the video or infrared images coming from the cameras 1616a-c in real time in order to discern where the user 1620's eyes are located over time, for example. The projector component 1606 can dynamically re-project the data points when significant changes to the eyepoint are detected.

Similarly, an ear location tracker component 1610 is used to track the location of the user 1620's ears and provide an accurate “line of hearing” to a feedback generator component 1614 so that accurate 3D sound is reproduced. By knowing the exact location of the end-user's ears and the point on the object 1624 from which the sound is to originate from, the feedback generator 1614 can modify the spatial characteristics of the audio to give the user 1620 the impression that the audio is emanating from the location on the object 1624. Alternatively, stereo or surround sound can be generated.

A user input detector 1612 tracks the user 1620's hands or other body parts so that user interaction with the object 1624 with a handheld tool or other means (e.g., 1622) is detected and communicated to the projector 1606 and the feedback generator 1614. A signal describing the user input including the location in the horizontal projection of the input, whether the input comes into contact with the object 1624 or otherwise manipulates the object 1624, and the type of input are provided to the projector 1606. For example, the type of input could be a command to cause the object 1624 to rotate, translate, scale or expose part of itself. Alternatively, or in addition to causing the object 1624's appearance to change, user input could trigger a sound or haptic response. Sounds and haptic responses are produced by the feedback generator 1614.

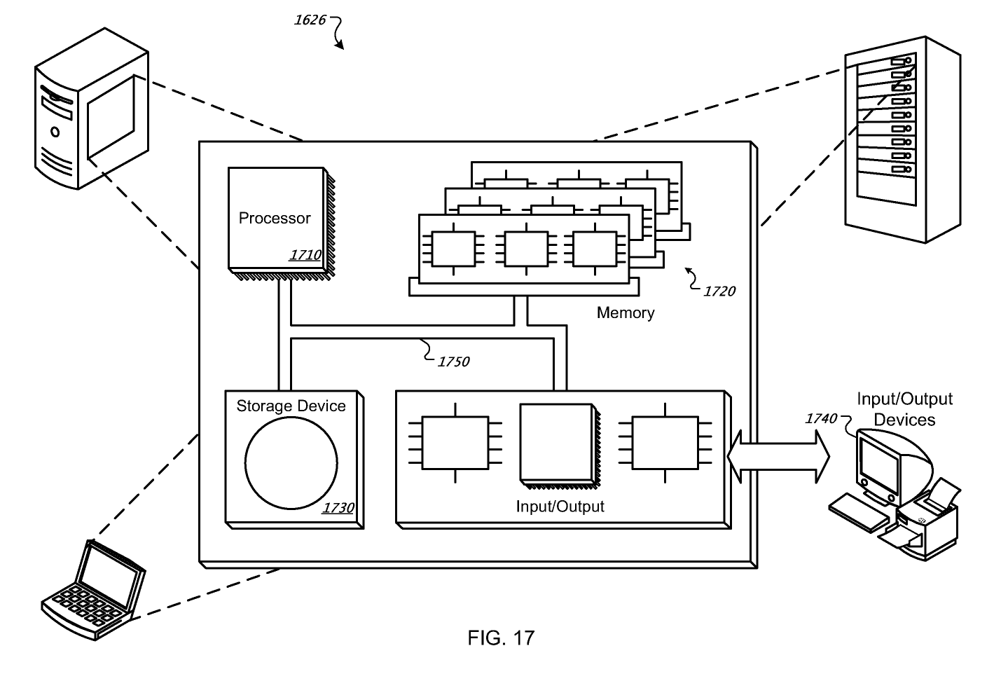

FIG. 17 is a schematic diagram of a generic computing device 1626 which can be used for practicing operations described in association with the technique 1500, for example. The device 1626 includes a processor 1710, a memory 1720, a storage device 1730, and input/output devices 1740. Each of the components 1710, 1720, 1730 and 1740 are interconnected using a system bus 1750. The processor 1710 is capable of processing instructions for execution within the device 1626. Such executed instructions can implement one or more components of system 1600, for example. The processor 1710 is single or multi-threaded and includes one or more processor cores. The processor 1710 is capable of processing instructions stored in the memory 1720 or on the storage device 1730 to display horizontal perspective images on the input/output device 1740.

The memory 1720 is a computer readable medium such as volatile or non volatile random access memory that stores information within the device 1626. The memory 1720 could store data structures representing the points for projection, for example. The storage device 1730 is capable of providing persistent storage for the device 1626. The storage device 1730 may be a floppy disk device, a hard disk device, an optical disk device, or a tape device, or other suitable persistent storage means. The input/output device 1740 provides input/output operations for the device 1626. In one implementation, the input/output device 1740 includes a keyboard and/or pointing device. In another implementation, the input/output device 1740 includes a horizontal display unit.

The system can include computer software components for creating and allowing interaction with horizontal projections. Examples of such software components include the horizontal projector component 1606, a multi-view component 1604, a feedback generator component 1614, an eye location tracker component 1608, an ear location tracker component 1610 and a user input detector 1612. In various implementations, the computing device 1626 is embodied in a personal computer.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processsing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the invention have been described. Other implementations are within the scope of the following claims. For example, the actions recited in the claims can be performed in a different order and still achieve desirable results.

What is claimed is:

1. A computer-implemented method, comprising:
identifying a set of three dimensional (3D) points for an object, the points obtained from a data source;
projecting each point's associated 3D location onto a drawing plane based on a location for a first eyepoint to create first projected points; and
creating a horizontal perspective image in open space from the first projected points.

2. The method of claim 1 where the data source is one or more of: a two dimensional (2D) image, a 3D image, a 3D model, a 3D object, a virtual world, a 3D chat room, a word processor document, an electronic game, a spreadsheet document, a database, or a network location.

3. The method of claim 1, further comprising:
obtaining a set of initial points from the data source, each initial point associated with less than three coordinates or more than three coordinates; and
determining a 3D location for each point based on the point's associated coordinates to create the set of three dimensional points for the object.

4. The method of claim 1, further comprising creating a stereoscopic image by:
projecting each point's 3D location in the set of points onto the drawing plane from a second eyepoint to create second projected points, the second eyepoint being offset from first eyepoint; and
creating a second horizontal perspective image in the open space based on the second projected points.

5. The method of claim 1, further comprising:
projecting each point's 3D location in the set of points onto the drawing plane from one or more additional eyepoints to create one or more additional sets of projected points, the additional eyepoints being offset from first eyepoint; and
creating one or more additional horizontal perspective images in the open space where each of the additional images is based one of the additional set of projected points.

6. The method of claim 1, further comprising:
obtaining audio information associated with a point in the first set of projected points; and
causing generation of audio based on the audio information.

7. The method of claim 6 where the generated audio is binaural, stereo or surround sound.

8. The method of claim 1, further comprising:
obtaining tactile information associated with a point in the first set of projected points; and
causing generation of haptic feedback based on the tactile information.

9. The method of claim 1 where the image is displayed on a substantially horizontal surface.

10. A computer program product, encoded on a tangible computer-readable medium, operable to cause data processing apparatus to perform operations comprising:
identifying a set of three dimensional (3D) points for an object, the points obtained from a data source;
projecting each point's associated 3D location onto a drawing plane based on a location for a first eyepoint to create first projected points; and
creating a horizontal perspective image in open space from the first projected points.

11. The program product of claim 10 where the data source is one or more of: a two dimensional (2D) image, a 3D image, a 3D model, a 3D object, a virtual world, a 3D chat room, a word processor document, an electronic game, a spreadsheet document, a database, or a network location.

12. The program product of claim 10, further operable to cause the data processing apparatus to perform operations comprising:
obtaining a set of initial points from the data source, each initial point associated with less than three coordinates or more than three coordinates; and
determining a 3D location for each point based on the point's associated coordinates to create the set of three dimensional points for the object.

13. The program product of claim 10, further comprising creating a stereoscopic image by:
projecting each point's 3D location in the set of points onto the drawing plane from a second eyepoint to create second projected points, the second eyepoint being offset from first eyepoint; and
creating a second horizontal perspective image in the open space based on the second projected points.

14. The program product of claim 10, further operable to cause the data processing apparatus to perform operations comprising:
projecting each point's 3D location in the set of points onto the drawing plane from one or more additional eyepoints to create one or more additional sets of projected points, the additional eyepoints being offset from first eyepoint; and
creating one or more additional horizontal perspective images in the open space where each of the additional images is based one of the additional set of projected points.

15. The program product of claim 10, further operable to cause the data processing apparatus to perform operations comprising:
obtaining audio information associated with a point in the first set of projected points; and
causing generation of audio based on the audio information.

16. The program product of claim 15 where the generated audio is binaural, stereo or surround sound.

17. The program product of claim 10, further operable to cause the data processing apparatus to perform operations comprising:
obtaining tactile information associated with a point in the first set of projected points; and
causing generation of haptic feedback based on the tactile information.

18. The program product of claim 10 where the image is displayed on a substantially horizontal surface.

19. A system, comprising:
a horizontal display for presenting a horizontal perspective image to a user;
one or more computing devices configured to perform operations comprising:
identifying a set of three dimensional (3D) points for an object, the points obtained from a data source;
projecting each point's associated 3D location onto a drawing plane based on a location for a first eyepoint to create first projected points; and
creating a horizontal perspective image on the display from the first projected points.

20. The system of claim 19 where the data source is one or more of: a two dimensional (2D) image, a 3D image, a 3D model, a 3D object, a virtual world, a 3D chat room, a word processor document, an electronic game, a spreadsheet document, a database, or a network location.

21. The system of claim 19, further comprising:
obtaining a set of initial points from the data source, each initial point associated with less than three coordinates or more than three coordinates; and
determining a 3D location for each point based on the point's associated coordinates to create the set of three dimensional points for the object.
